(19) United States
(12) Patent Application Publication
(10) Pub. No.: US 2013/0176453 A1
(43) Pub. Date: Jul. 11, 2013

(54) METHODS, APPARATUSES AND COMPUTER PROGRAM PRODUCTS FOR FACILITATING IMAGE REGISTRATION BASED IN PART ON USING SENSOR DATA

(71) Applicants: Sujeet Shyamsundar Mate, Tampere (FI); Igor Danilo Diego Curcio, Tampere (FI); Kostadin Nikolaev Dabov, Tampere (FI)

(72) Inventors: Sujeet Shyamsundar Mate, Tampere (FI); Igor Danilo Diego Curcio, Tampere (FI); Kostadin Nikolaev Dabov, Tampere (FI)

(73) Assignee: NOKIA CORPORATION, Espoo (FI)

(21) Appl. No.: 13/345,162

(22) Filed: Jan. 6, 2012

(51) Int. Cl. H04N 5/228

(52) U.S. Cl. 348/222.1; 348/E05.031

(57) ABSTRACT

An apparatus for performing image registration based on sensor data may include a processor and memory storing executable computer program code that cause the apparatus to at least perform operations including capturing successive images corresponding to a scene. The successive images are captured during successive exposure time intervals. The computer program code may further cause the apparatus to detect sensor data during the exposure time intervals. The sensor data may be utilized to determine horizontal and vertical orientation differences between at least two consecutive images of successive images. The computer program code may further cause the apparatus to perform registration to align pixels of the two images by shifting pixels of a first image of the two images to align with pixels of a second image of the two images based on the horizontal orientation difference and the vertical orientation difference. Corresponding methods and computer program products are also provided.

Embodiments of the present invention relate generally to image recording and, more particularly, relate to a method, apparatus, and computer program product for image registration based in part on sensor data.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Due to the now ubiquitous nature of electronic communication devices, people of all ages and education levels are utilizing electronic devices to communicate with other individuals or contacts, receive services and/or share information, media and other content. One area in which there is a demand to increase ease of information transfer relates to image processing.

At present, composing high dynamic range images from multiple low dynamic range images is a standard feature in modern digital cameras. For instance, registration of multiple images of a given scene may be achieved by composing high dynamic range images from multiple low dynamic range images of a given scene or simply for fusion of multiple images. A common way to achieve this is to use exposure bracketing, in which an exposure time is altered when capturing a sequence of images (e.g., each having a standard dynamic range of a camera being used). As may be expected, any motion of the camera during this process may result in an undesirable translation of the scene being captured in each of the captured images.

As such, it may be beneficial to provide a mechanism to alleviate undesirable translation associated with registration of multiple captured images of a given scene in order to improve the visual perception of one or more images.

### BRIEF SUMMARY

A method, apparatus and computer program product are therefore provided according to an example embodiment of the invention to perform image registration based in part on utilizing sensor data. In some example embodiments, mobile terminals including media capturing devices (e.g., camera-enabled handheld electronic devices) may have multiple sensors that may assist different applications and services in contextualizing the manner in which the mobile terminals are used. Sensor (e.g., context) data and streams of such data may be recorded together with media data such as, for example, an image(s), a video(s) or other modality of recording (e.g., speech). In some example embodiments, location information (e.g., Global Positioning System (GPS) location information) may, but need not, be included with the media data as well as other information such as, for example, sensor data including but not limited to streams of compass, accelerometer, or gyroscope readings or measurements.

Moreover, some example embodiments may provide a mechanism for registration of multiple images of a given scene or location by exploiting sensor measurements recorded simultaneously with the image capturing which may be stored together with the captured images (e.g., as metadata for the capturing process). The angle of view (e.g., used in the image capturing) may be stored together with the captured images and may be used to obtain or determine correspondence between rotational differences of a media capturing device (e.g., a camera) and pixel differences between consecutively captured images.

In an example embodiment, the sensor data may be collected periodically during the image acquisition or nearly periodically (e.g., having some variation in the time interval between two sensor measurements) together with a timestamp(s) that may be relevant with the beginning of the image capturing. The sensors of the mobile terminal may include, but are not limited to, a gyroscope(s), an accelerometer(s), a compass(es), or any other suitable sensors. The determined correspondence between rotational differences of the media capturing device and pixel difference between consecutively captured images may be utilized to align the consecutively captured images such that the orientations of the consecutively captured images match.

In one example embodiment, a method for performing image registration is provided. The method includes capturing a plurality of successive images corresponding to a given scene. The images are captured during respective exposure time intervals. The method may also include detecting sensor data during the exposure time intervals. The sensor data may be utilized in part to determine a horizontal orientation difference between at least two consecutive images of the successive images and a vertical orientation difference between the two consecutive images. The method may also include performing registration to align pixels of the two consecutive images by shifting pixels of a first image of the two consecutive images to align with pixels of a second image of the two consecutive images based in part on the determined horizontal orientation difference and the determined vertical orientation difference.

In another example embodiment, an apparatus for performing image registration is provided. The apparatus may include a processor and memory including computer program code. The memory and the computer program code are configured to, with the processor, cause the apparatus to at least perform operations including capturing a plurality of successive images corresponding to a given scene. The images are captured during respective exposure time intervals. The memory and computer program code are also configured to, with the processor, cause the apparatus to detect sensor data during the exposure time intervals. The sensor data may be utilized in part to determine a horizontal orientation difference between at least two consecutive images of the successive images and a vertical orientation difference between the two consecutive images. The memory and computer program code are also configured to, with the processor, cause the apparatus to perform registration to align pixels of the two consecutive images by shifting pixels of a first image of the two consecutive images to align with pixels of a second image of the two consecutive images based in part on the determined horizontal orientation difference and the determined vertical orientation difference.

In another example embodiment, a computer program product for performing image registration is provided. The computer program product includes at least one computer-readable storage medium having computer-executable program code portions stored therein. The computer-executable program code instructions may include program code instructions configured to facilitate capture of a plurality of successive images corresponding to a given scene. The images are captured during respective exposure time intervals. The program code instructions may also be configured to detect sensor data during the exposure time intervals. The sensor data may be utilized in part to determine a horizontal orientation difference between at least two consecutive images of the successive images and a vertical orientation difference between the two consecutive images. The program code instructions may also be configured to perform registration to align pixels of the two consecutive images by shifting pixels of a first image of the two consecutive images to align with pixels of a second image of the two consecutive images based in part on the determined horizontal orientation difference and the determined vertical orientation difference.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an example embodiment of the invention;

FIG. 2 is a schematic block diagram of an apparatus according to an example embodiment of the invention;

FIG. 3 is a schematic block diagram of an orientation module according to an example embodiment of the invention;

FIG. 4 is a diagram illustrating exposure intervals for captured images according to an example embodiment of the invention;

FIG. 5 is a diagram illustrating a manner in which rotation of a media capturing device affects pixel shift between two consecutive images according to an example embodiment of the invention; and

FIG. 6 is a flowchart of an example method of performing image registration according to an example embodiment of the invention.

### DETAILED DESCRIPTION

Some embodiments of the invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, image registration may, but need not, denote alignment of at least two consecutively captured images such that the orientation of the images matches each other. In this regard, an example embodiment may determine the correspondence relationships among images with varying degrees of overlap. During image registration (also referred to herein as image alignment) one of the consecutively captured images may be referred to herein as a reference or source image and a second image of the consecutively captured images may be referred to herein as a target or sensed image. In one example embodiment, image registration may be performed by spatially transforming the target image to align with the reference image. Based in part on utilizing a determined correspondence between a number of points in images, for example, a transformation may be determined to map the target image to the reference images, thereby establishing point-by-point correspondence between the reference and target images.

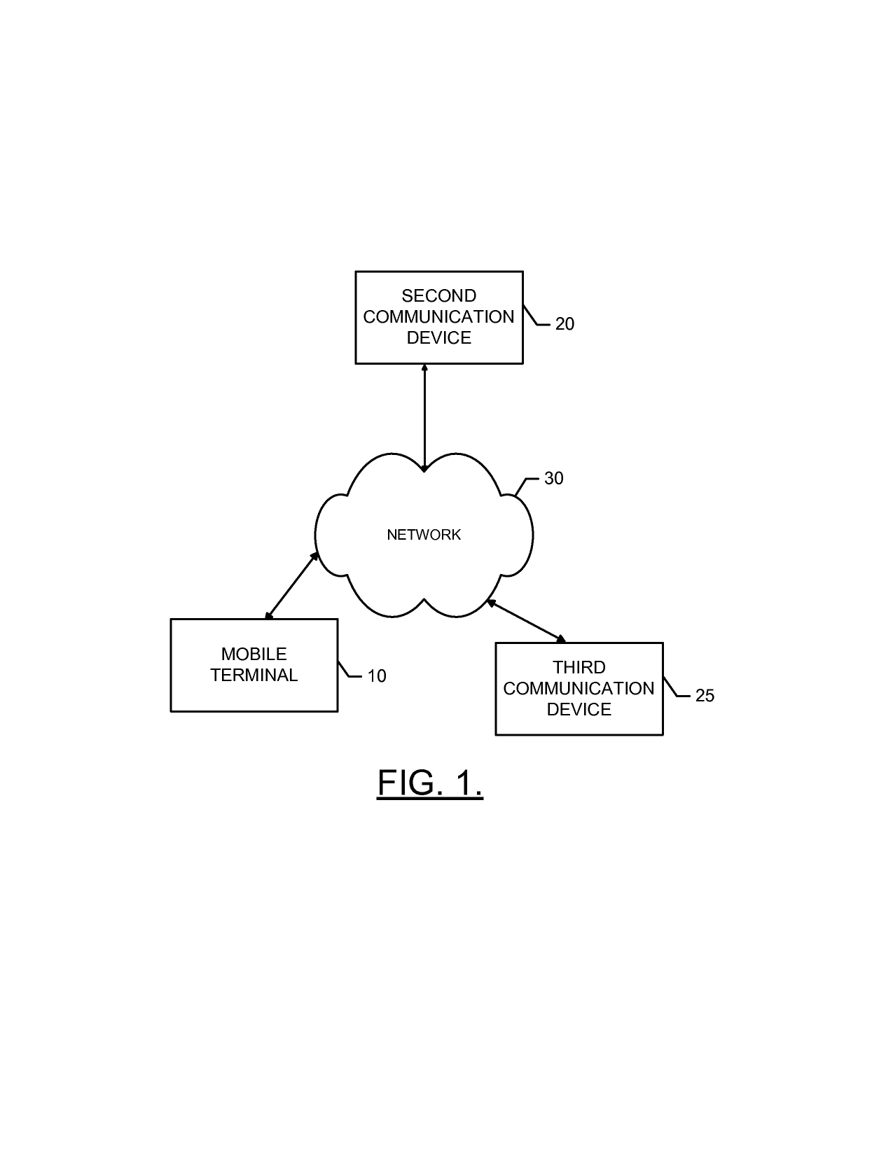

FIG. 1 illustrates a generic system diagram in which a device such as a mobile terminal 10 is shown in an example communication environment. As shown in FIG. 1, an embodiment of a system in accordance with an example embodiment of the invention may include a first communication device (e.g., mobile terminal 10) and a second communication device 20 capable of communication with each other via a network 30. In some cases, an embodiment of the present invention may further include one or more additional communication devices, one of which is depicted in FIG. 1 as a third communication device 25. In one embodiment, not all systems that employ an embodiment of the present invention may comprise all the devices illustrated and/or described herein. While an embodiment of the mobile terminal 10 and/or second and third communication devices 20 and 25 may be illustrated and hereinafter described for purposes of example, other types of terminals, such as portable digital assistants (PDAs), tablets, pagers, mobile televisions, mobile telephones, gaming devices, laptop computers, cameras, video recorders, audio/video players, radios, global positioning system (GPS) devices, Bluetooth headsets, Universal Serial Bus (USB) devices or any combination of the aforementioned, and other types of voice and text communications systems, can readily employ an embodiment of the present invention. Furthermore, devices that are not mobile, such as servers and personal computers may also readily employ an embodiment of the present invention.

The network 30 may include a collection of various different nodes (of which the second and third communication devices 20 and 25 may be examples), devices or functions that may be in communication with each other via corresponding wired and/or wireless interfaces. As such, the illustration of FIG. 1 should be understood to be an example of a broad view of certain elements of the system and not an all-inclusive or detailed view of the system or the network 30. Although not necessary, in one embodiment, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE) or Evolved Universal Terrestrial Radio Access Network (E-UTRAN), Self Optimizing/Organizing Network (SON) intra-LTE, inter-Radio Access Technology (RAT) Network and/or the like. In one embodiment, the network 30 may be a peer-to-peer (P2P) network.

One or more communication terminals such as the mobile terminal 10 and the second and third communication devices 20 and 25 may be in communication with each other via the network 30 and each may include an antenna or antennas for transmitting signals to and for receiving signals from one or more base sites. The base sites could be, for example one or more base stations (BS) that is a part of one or more cellular or mobile networks or one or more access points (APs) that may be coupled to a data network, such as a Local Area Network (LAN), Wireless Local Area Network (WLAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other. For example, the mobile terminal 10 and the second and third communication devices 20 and 25 as well as other devices may communicate according to numerous communication protocols including Hypertext Transfer Protocol (HTTP), Real-time Transport Protocol (RTP), Session Initiation Protocol (SIP), Real Time Streaming Protocol (RTSP) and/or the like, to thereby carry out various communication or other functions of the mobile terminal 10 and the second and third communication devices 20 and 25, respectively.

Furthermore, although not shown in FIG. 1, the mobile terminal 10 and the second and third communication devices 20 and 25 may communicate in accordance with, for example, Radio Frequency (RF), Near Field Communication (NFC), Bluetooth (BT), Infrared (IR) or any of a number of different wireline or wireless communication techniques, including Local Area Network (LAN), Wireless LAN (WLAN), Worldwide Interoperability for Microwave Access (WiMAX), Wireless Fidelity (Wi-Fi), Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In an example embodiment, the first communication device (e.g., the mobile terminal 10) may be a mobile communication device such as, for example, a wireless telephone or other devices such as a personal digital assistant (PDA), mobile computing device, camera, video recorder, audio/video player, positioning device, game device, television device, radio device, or various other like devices or combinations thereof. The second communication device 20 and the third communication device 25 may be mobile or fixed communication devices. However, in one example, the second communication device 20 and the third communication device 25 may be servers, remote computers or terminals such as personal computers (PCs) or laptop computers.

In an example embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities.

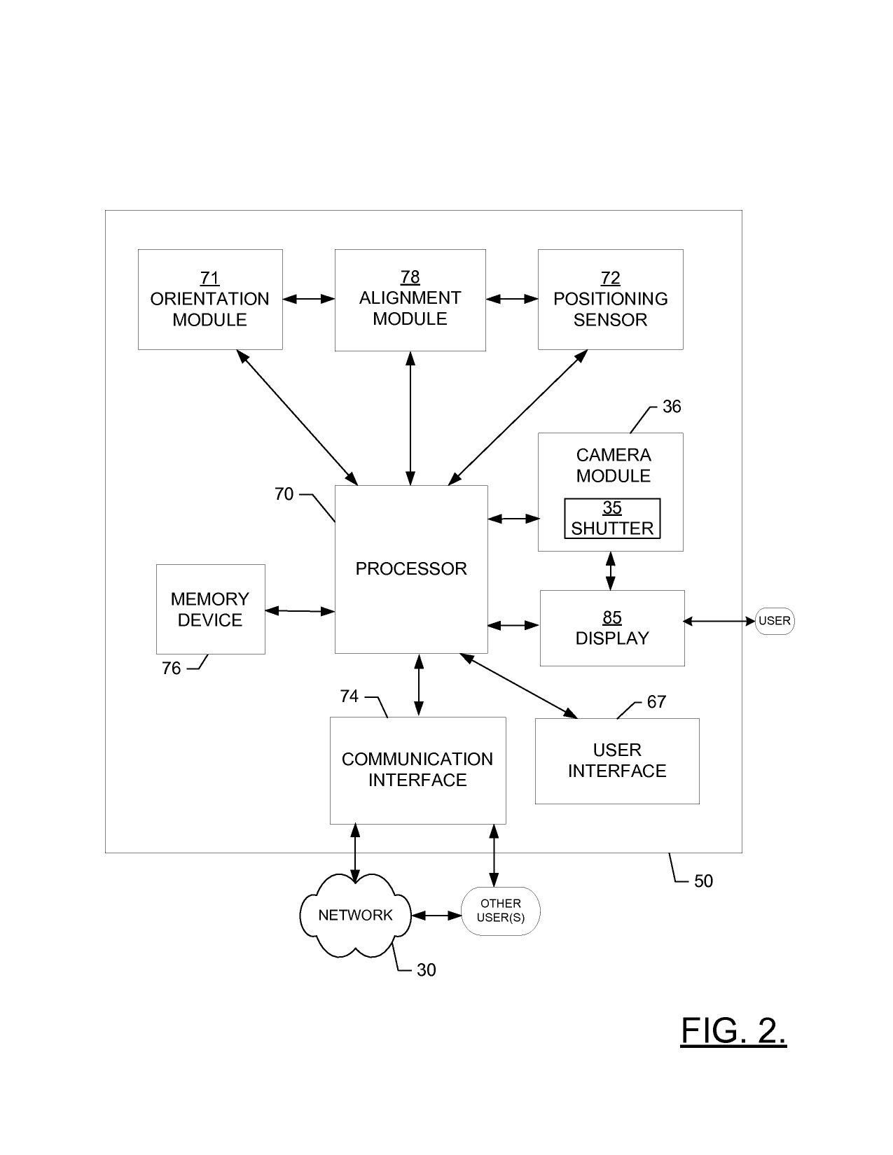

In an example embodiment, the mobile terminal 10 as well as the second and third communication devices 20 and 25 may employ an apparatus (e.g., apparatus of FIG. 2) capable of employing an embodiment of the invention. In one example embodiment, the second communication device 20 may be a network device such as, for example, a server capable of providing media data (e.g., an image(s), a video(s), audio data, etc.) to the third communication device 25 and/or the mobile terminal 10. In an alternative example embodiment, the third communication device 25 may be a network device such as, for example, a server capable of providing media data (e.g., an image(s), a video(s), audio data, etc.) to the second communication device 20 and/or the mobile terminal 10. In an example embodiment, the mobile terminal 10 may include one or more sensor devices, which may generate sensor data that may be utilized by the mobile terminal 10 to determine orientation and field of view of a media capturing device (e.g., a camera (e.g., camera module 36 of FIG. 2)) that captures media data (e.g., an image(s), a video(s), speech data, etc.). The mobile terminal 10 may utilize the sensor data in part to align captured images corresponding to a same scene or a location.

FIG. 2 illustrates a schematic block diagram of an apparatus according to an example embodiment. An example embodiment of the invention will now be described with reference to FIG. 2, in which certain elements of an apparatus 50 are displayed. The apparatus 50 of FIG. 2 may be employed, for example, on the mobile terminal 10 (and/or the second communication device 20 or the third communication device 25). Alternatively, the apparatus 50 may be embodied on a network device of the network 30. However, the apparatus 50 may alternatively be embodied at a variety of other devices, both mobile and fixed (such as, for example, any of the devices listed above). In some cases, an embodiment may be employed on a combination of devices. Accordingly, one embodiment of the invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in a certain embodiment.

Referring now to FIG. 2, the apparatus 50 may include or otherwise be in communication with a processor 70, a user interface 67, a communication interface 74, a memory device 76, a display 85, an orientation module 71, an alignment module 78, a positioning sensor 72 and a camera module 36. In one example embodiment, the display 85 may be a touch screen display. The memory device 76 may include, for example, volatile and/or non-volatile memory. For example, the memory device 76 may be an electronic storage device (e.g., a computer readable storage medium) comprising gates configured to store data (e.g., bits) that may be retrievable by a machine (e.g., a computing device like processor 70). In an example embodiment, the memory device 76 may be a tangible memory device that is not transitory. The memory device 76 may be configured to store information, data, files, applications, instructions or the like for enabling the apparatus to carry out various functions in accordance with an example embodiment of the invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content (e.g., pictures, images, videos, audio data, etc.).

The memory device 76 may store geocoded information that may be associated with location information corresponding to coordinates such as, for example, latitude, longitude and/or altitude coordinates of objects (e.g., real world objects). The geocoded information may be evaluated by the processor 70 and/or alignment module 78 and data associated with the geocoded information may be provided to a camera view of a display (e.g., display 85).

The apparatus 50 may, in one embodiment, be a mobile terminal (e.g., mobile terminal 10) or a fixed communication device or computing device configured to employ an example embodiment of the invention. However, in one embodiment, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the invention on a single chip or as a single “system on a chip.” As such, in some cases, a chip or chipset may constitute means for performing one or more operations for providing the functionalities described herein. Additionally or alternatively, the chip or chipset may constitute means for enabling user interface navigation with respect to the functionalities and/or services described herein.

The processor 70 may be embodied in a number of different ways. For example, the processor 70 may be embodied as one or more of various processing means such as a coprocessor, microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like. In an example embodiment, the processor 70 may be configured to execute instructions stored in the memory device 76 or otherwise accessible to the processor 70. As such, whether configured by hardware or software methods, or by a combination thereof, the processor 70 may represent an entity (e.g., physically embodied in circuitry) capable of performing operations according to an embodiment of the invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and operations described herein when the instructions are executed. However, in some cases, the processor 70 may be a processor of a specific device (e.g., a mobile terminal or network device) adapted for employing an embodiment of the invention by further configuration of the processor 70 by instructions for performing the algorithms and operations described herein. The processor 70 may include, among other things, a clock, an arithmetic logic unit (ALU) and logic gates configured to support operation of the processor 70.

In an example embodiment, the processor 70 may be configured to operate a connectivity program, such as a browser, Web browser or the like. In this regard, the connectivity program may enable the apparatus 50 to transmit and receive Web content, such as for example location-based content or any other suitable content, according to a Wireless Application Protocol (WAP), for example. The processor 70 may also be in communication with a display 85 and may instruct the display to illustrate any suitable information, data, content (e.g., media content) or the like.

Meanwhile, the communication interface 74 may be any means such as a device or circuitry embodied in either hardware, a computer program product, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet or other mechanisms.

The user interface 67 may be in communication with the processor 70 to receive an indication of a user input at the user interface 67 and/or to provide an audible, visual, mechanical or other output to the user. As such, the user interface 67 may include, for example, a keyboard, a mouse, a joystick, a display, a touch screen, a microphone, a speaker, or other input/output mechanisms. In an example embodiment in which the apparatus is embodied as a server or some other network devices, the user interface 67 may be limited, remotely located, or eliminated. The processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

The apparatus 50 may include a media capturing element (also referred to herein as a media capturing device), such as camera module 36. The camera module 36 may include a camera, video and/or audio module, in communication with the processor 70 and the display 85. The camera module 36 may be any means for capturing an image, video and/or audio for storage, display or transmission. For example, the camera module 36 may include a digital camera capable of forming a digital image file from one or more captured images. As such, the camera module 36 may include all hardware, such as a lens or other optical component(s), and software necessary for creating a digital image file(s) from a captured image(s). Alternatively, the camera module 36 may include only the hardware needed to view an image(s), while a memory device (e.g., memory device 76) of the apparatus 50 stores instructions for execution by the processor 70 in the form of software necessary to create a digital image file(s) from a captured image(s). In an example embodiment, the camera module 36 may further include a processing element such as a co-processor which assists the processor 70 in processing image data and an encoder and/or decoder for compressing and/or decompressing image data. The encoder and/or decoder may encode and/or decode according to a Joint Photographic Experts Group, (JPEG) standard format or other like formats for two-dimensional (2D), three-dimensional (3D) video such as the Motion Picture Experts Group (MPEG) formats.

In some cases, the camera module 36 may provide live image data to the display 85. In this regard, the camera module 36 may facilitate or provide a camera view to the display 85 to show live image data, still image data, video data, or any other suitable data. In an example embodiment, the camera module 36 may capture a sequence of images at a given scene or location. These sequential images may, but need not, be captured by the camera module 36 with varying exposure times. The exposure times may relate to an amount of time a shutter 35 is activated or open for exposing photographic film or a light-sensitive electronic sensor to light to capture a permanent image(s) of a scene(s) or location.

Moreover, in an example embodiment, the display 85 may be located on one side of the apparatus 50 and the camera module 36 may include a lens positioned on the opposite side of the apparatus 50 with respect to the display 85 to enable the camera module 36 to capture images on one side of the apparatus 50 and present a view of such images to the user positioned on the other side of the apparatus 50.

In addition, the apparatus 50 may include a positioning sensor 72. The positioning sensor 72 may include, for example, a global positioning system (GPS) sensor/receiver, an assisted global positioning system (Assisted-GPS) sensor, a Bluetooth (BT)-GPS mouse, other GPS or positioning receivers or the like. However, in one example embodiment, the positioning sensor 72 may include a pedometer or inertial sensor. In this regard, the positioning sensor 72 may be capable of determining a location of the apparatus 50, such as, for example, longitudinal and latitudinal directions of the apparatus 50, or a position relative to a reference point such as a destination or start point. The positioning sensor 72 may also be capable of determining an altitude of the apparatus 50 and use the altitude information in determining the location of the apparatus 50. Information from the positioning sensor 72 may then be communicated to a memory of the apparatus 50 or to another memory device to be stored as a position history or location information.

In an example embodiment, the apparatus 50 may further include (or be in communication with) an orientation module 71. The orientation module 71 may be any means such as a device or circuitry embodied in either hardware or a combination of hardware and software that is configured to determine the orientation of apparatus 50 and/or of the field of view (also referred to herein as angle of view) of the camera module 36 of the apparatus 50.

The orientation module 71 may be configured to determine the orientation of apparatus 50 relative to a reference. In some cases, the reference may be a particular direction, such as North or another cardinal direction. However, other references may also be employed. As such, in one embodiment, the orientation module 71 may include a compass or other orientation sensor, such as, for example, a gyroscope, configured to determine the heading of the apparatus 50 or direction that the lens of the camera module 36 is pointing. The direction or heading may be determined in terms of degrees (e.g., 0 to 360 degrees) offset from the reference. In some cases, the reference may be fixed (e.g., a fixed directional reference), while in other cases, the reference may be a reference of opportunity such as a prominent feature in an image captured by the camera module or simply an initial orientation.

In an example embodiment, the orientation of the field of view of the camera module 36 may be compared to the reference in order to determine the current orientation of the apparatus 50. Thus, for example, given an initial image, a particular feature may be selected as the reference. Thereafter, as the field of view is altered, the orientation module 71 may be configured to determine the orientation of the field of view of the camera module 36 based on the speed or amount of movement relative to the reference. While one embodiment may only determine orientation in a single plane (e.g., parallel to the surface of the earth), another embodiment may allow for orientation determination including an elevation aspect and/or axial aspect shifts. Thus, for example, the orientation module 71 may be configured to determine pitch and/or yaw of the apparatus 50 (e.g., pitch defining a degree of elevation and yaw defining an axial rotation). As such, for example, the orientation module 71 may include a device or other means for determining the orientation of the apparatus 50 (or the field of view of the camera module 36), which may be referred to as orientation information. In one embodiment, the orientation module 71 may include an electronic/digital compass, a horizon sensor, gravity sensor, accelerometer, gyroscope, magnetometer and/or the like or any other sensor that may be useful in determining orientation information.

In an example embodiment, the processor 70 may be embodied as, include or otherwise control the alignment module. The alignment module 78 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the alignment module 78 as described below. Thus, in an example in which software is employed, a device or circuitry (e.g., the processor 70 in one example) executing the software forms the structure associated with such means.

In one example embodiment the alignment module 78 may perform registration (e.g., alignment of successively captured images at a given scene/location) on multiple images of a given scene based in part on utilizing sensor measurements recorded/obtained simultaneously with an image(s) captured by the camera module 36. The alignment module 78 may obtain the sensor measurements from the positioning sensor 72 and/or the orientation module 71. The alignment module 78 may facilitate storage (e.g., in the memory device 76) of the sensor measurements together with the captured image(s) (e.g., as metadata for the capturing process). In this regard, the angle of view (e.g., used in the image capturing by the camera module 36) may be stored (e.g., in the memory device 76) together with the captured images and may be utilized by the alignment module 78 to determine correspondence between rotational differences of the camera module 36 in instances in which multiple images are captured and to determine pixel differences between consecutive or successively captured images. Based in part on utilizing the sensor measurements, the alignment module 78 may determine any change in orientation(s) (e.g., a horizontal orientation, a vertical orientation) of a prior captured image(s) of a sequence of consecutively captured images. As such, the module 78 may utilize this orientation information to align at least two consecutive images of the sequence of captured images.

In one example embodiment, sensor data (e.g., sensor measurements) may be collected by the alignment module 78 periodically during the image acquisition or nearly periodically (e.g., having some variation in the time interval between two or more sensor measurements detected by the orientation module 71 and/or positioning sensor 72) together with timestamps that may indicate the instance in which or time (e.g., the beginning) an image(s) was captured by the camera module 36. Additionally, a timestamp(s) may indicate the time in which a sensor measurement(s) is obtained.

In an example embodiment, the captured images (e.g., successively captured images) may be stored (e.g., in memory device 76) persistently together with the corresponding sensor data (e.g., sensor measurements). In this manner, the alignment module 78 may retrieve the images and sensor data and perform fusion or alignment (aligning the orientations of the images such that the orientations match) of the images at a suitable time after the images are captured. For example, for purposes of illustration and not of limitation, the alignment module 78 may retrieve the images and sensor data from memory (e.g., memory device 76) and may perform alignment of the orientations of the images at a suitable time after the images are captured in an instance in which the resources of the apparatus 50 are under-utilized, are being utilized at acceptable levels or when the battery power of the apparatus 50 is at a suitable level, etc. The alignment module 78 may retrieve the images and sensor data from memory (e.g., memory device 76) and may perform alignment of the orientations of the images at any other suitable times after the images are captured.

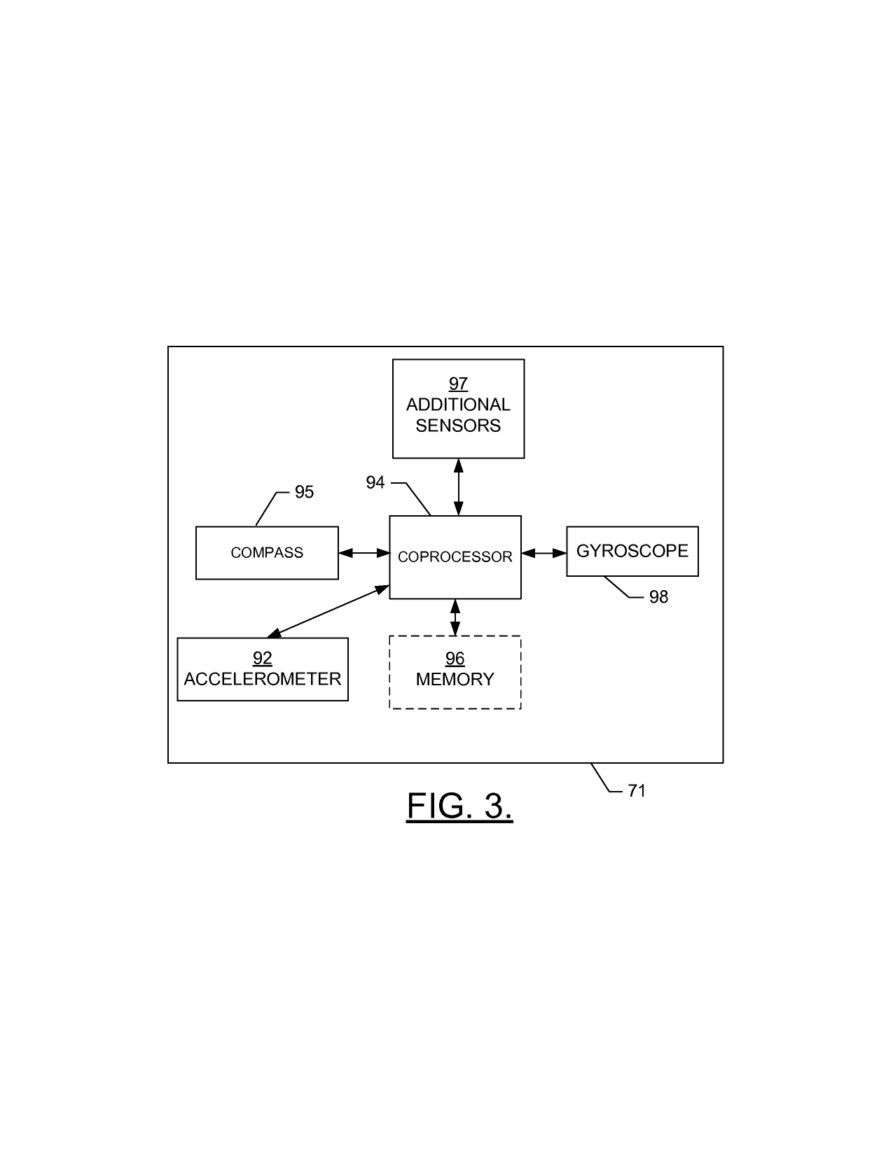

Referring now to FIG. 3, a diagram of the orientation module of the apparatus of FIG. 2 is provided. As shown in FIG. 3, the orientation module 71 may include a compass 95, an accelerometer 92, a gyroscope 98, one or more additional sensors 97, a coprocessor 94 and optionally a memory 96. The additional sensors 97 may include but are not limited to a horizon sensor, gravity sensor, magnetometer and/or the like or any other sensor(s) that may be useful in determining orientation information. The memory 96 may comprise volatile and/or non-volatile memory, and may store content, data and/or the like. For example, the memory may store content, data, information, and/or the like transmitted from, and/or received by, the orientation module. In an example embodiment, the memory 96 may store determined sensor data, which may include but is not limited to, gyroscope measurements, accelerometer measurements, compass measurements and measurements of sensors 97.

In an example embodiment, the coprocessor 94 may be any means such as a device or circuitry operating in accordance with software or otherwise embodied in hardware or a combination of hardware and software (e.g., coprocessor 94 operating under software control, the coprocessor 94 embodied as an ASIC or FPGA specifically configured to perform the operations described herein, or a combination thereof) thereby configuring the device or circuitry to perform the corresponding functions, as described herein. Thus, in an example in which software is employed, a device or circuitry (e.g., the coprocessor 94 in one example) executing the software forms the structure associated with such means.

In an example embodiment, the coprocessor 94 may be embodied in a number of different ways. For example, the coprocessor 94 may be embodied as one or more of various processing means such as a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like. In one example embodiment, the coprocessor 94 may be configured to execute instructions stored in the memory 96 or otherwise accessible to the coprocessor 94. As such, whether configured by hardware or software methods, or by a combination thereof, the coprocessor 94 may represent an entity (e.g., physically embodied in circuitry) capable of performing operations according to an embodiment of the invention while configured accordingly. Thus, for example, when the coprocessor 94 is embodied as an ASIC, FPGA or the like, the coprocessor 94 may be specifically configured hardware for conducting the operations described herein. Alternatively, as another example, when the coprocessor 94 is embodied as an executor of software instructions, the instructions may specifically configure the coprocessor 94 to perform the algorithms and operations described herein when the instructions are executed.

In one example embodiment, coprocessor 94 may obtain the gyroscope measurements from the gyroscope 92 and may utilize the gyroscope measurements to determine orientation information of a media capturing device (e.g., camera module 36) capturing images. The gyroscope 98 may be configured to determine the heading of the apparatus 50 or direction that the lens of the camera module 36 is pointing. The direction or heading may be determined in terms of degrees (e.g., 0 to 360 degrees) offset from a reference. As such, the gyroscope measurements may be utilized to determine the orientation of the camera module 36 in three dimensions (3D) in instances in which the camera module 36 captures images. As such, the coprocessor 94 may utilize the gyroscope measurements to determine the horizontal orientation and the vertical orientation of captured images, as described more fully below.

In another example embodiment, the coprocessor 94 may obtain one or more compass measurements from compass 95 and one or more accelerometer measurements from the accelerometer 92 to determine orientation information indicating the orientation(s) in which the camera module 36 captured one or more images. In one example embodiment, the coprocessor 94 may utilize the compass measurements, obtained from compass 95, to determine the orientation of an image(s) in the horizontal plane (also referred to herein as horizontal orientation), as described more fully below. Additionally, in an example embodiment, the coprocessor 94 may utilize the accelerometer measurements, obtained from accelerometer 92, to determine the orientation of an image(s) in the vertical plane (also referred to herein as vertical orientation), as described more fully below.

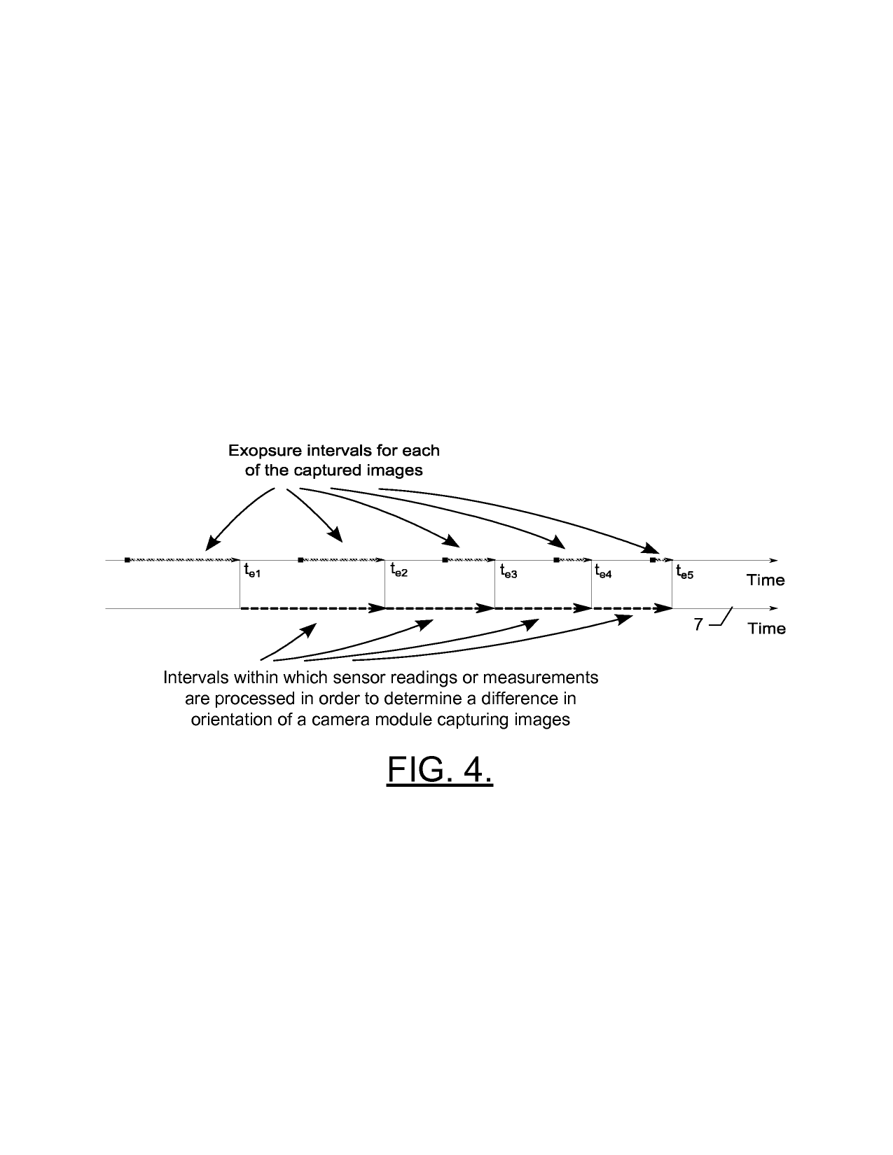

Referring now to FIG. 4, a diagram illustrating intervals in which sensor data is obtained for respective images is provided according to an example embodiment. The sensor data (e.g., sensor measurements) may be collected, by the alignment module 78 from the coprocessor 94, for example, during an exposure interval for each of the captured images. For example, in the example embodiment of FIG. 4, there are five exposure intervals (also referred to herein as exposure time intervals) tₑ₁, tₑ₂, tₑ₃, tₑ₄ and tₑ₅ corresponding to five sequentially captured images at a same scene or location. Sensor data for the first image in the sequence may be obtained during exposure time interval tₑ₁, and sensor data for the first image in the sequence may be captured during exposure time interval tₑ₂, so on and so forth. The sensor data may be sensor measurements including, but not limited, to gyroscope measurements, compass measurements, accelerometer measurements and any other suitable sensor measurements. The sensor data may be obtained by the alignment module 78 from the orientation module 71 (e.g., via the coprocessor 94 and/or the compass 95, the gyroscope 98, the accelerometer 92, the additional sensors 97) during the exposure time intervals tₑ₁, tₑ₂, tₑ₃, tₑ₄ and tₑ₅. It should be pointed out although FIG. 4 illustrates five exposure time intervals corresponding to five captured images any suitable number of exposure time intervals and captured images may be shown in FIG. 4 without departing from the spirit and scope of the invention.

In the example embodiment of FIG. 4, the alignment module 78 may determine the differences in horizontal orientation and the vertical orientation between each of two successively captured images (e.g., image one and image two, image two and image three, etc). In this regard, the alignment module 78 may analyze the sensor data obtained during the exposure time interval of an image (one of the five images) and may use this sensor data to determine the change in the orientation of the camera module 36 for each captured image that is subsequent (e.g., a target image) to the most recent previously captured image (e.g., a reference image) of the sequence of images.

The bottom time axis 7 shown in FIG. 4 illustrates four intervals in which the alignment module 78 may separately process or analyze the sensor data in order to determine the differences in the camera orientation between each two consecutive captured images.

Two approaches for performing image registration may be provided by some example embodiments. In a first approach, the alignment module 78 may integrate (e.g., in time) one or more sensor measurements such as, for example, gyroscope readings within each considered exposure interval in order to obtain the orientation (e.g., horizontal orientation, vertical orientation) difference between two consecutive captured images (e.g., image one and image two, image two and image three, etc.) at a same scene or location. The alignment module may determine the orientation (e.g., horizontal orientation, vertical orientation) difference between two consecutive captured images, as a discrete integral in time. For example, the alignment module 78 may determine a sum of sensor measurements such as, for example, gyroscope readings or measurements scaled by the time interval between two consecutive gyroscope readings. In this regard, the gyroscope (e.g., gyroscope 98) may return the pitch and yaw values at the time of image capture. Subsequently, these values are obtained, by the alignment module 78, for each image capture. The difference in pitch and yaw may be used by the alignment module 78 to estimate the vertical and horizontal translation of an image sensor.

In an example embodiment, a sensor(s) of the orientation module 71 such as, for example, the gyroscope 98 may determine an orientation(s) of the camera module 36 capturing successive images at a given scene/location in three dimensions during an exposure time interval. The coprocessor 94 of the orientation module 71 may utilize the data in three dimensions to determine the horizontal orientation and the vertical orientation in which the camera module 36 captured the successive images. The orientation module 71 may provide this information to the alignment module 78 to enable the alignment module to determine the difference in orientation (e.g., horizontal orientation, vertical orientation) between two consecutive images, as described more fully below. The alignment module 78 may utilize the determined differences (also referred to herein as angle of difference(s)) between the horizontal orientation and the vertical orientation for two consecutive images to align the images such that the two consecutive images may overlap evenly, as described more fully below.

In the second approach, sensors of the orientation module 71 such as, for example, the accelerometer 92 and the compass 95 may generate sensor data (e.g., sensor measurements) that is utilized to determine the orientations in which a camera module 36 captured two consecutive images. For instance, the accelerometer 92 may detect the vertical angle of difference (e.g., with respect to a horizontal plane) in which the camera module 36 captured images (e.g., successively captured images) during an exposure time interval. In this manner, the accelerometer 92 may determine the vertical orientation(s) in which a camera module 36 captures images during an exposure time interval. Additionally, the compass 95 may detect the horizontal angle of difference (e.g., in a horizontal direction) in which a camera module 36 captures images during an exposure time interval. In this regard, the compass 95 may detect the horizontal orientation(s) in which a camera module 36 may capture images (e.g., two successively captured images). In this manner, a combination of sensors such as, for example, the accelerometer 92 and the compass 95 may be utilized in part to determine the orientation of a camera module during an exposure time interval. The vertical orientations detected/determined by the accelerometer 92 and the horizontal orientations detected/determined by the compass 95 may be provided by the orientation module 71, via the coprocessor 94, to the alignment module 78 to enable the alignment module 78 to align two consecutive images, as described more fully below.

It should be pointed out that although the gyroscope measurements of gyroscope 98 may be utilized in part to determine the horizontal orientations (also referred to herein as angle of difference in horizontal direction) and vertical orientations (also referred to herein as angle of difference in vertical direction) in which the camera module 36 captures images, according to the first approach, any other suitable sensor(s) configured to generate sensor measurements indicating the orientation in which images are captured by the camera module 36 in three dimensions may be utilized. Additionally, in the second approach, a sensor(s) other than the accelerometer 92 may be utilized in part to determine the vertical orientations in which the camera module 36 captures images and a sensor(s) other than the compass 95 may be utilized in part to determine the horizontal orientations in which the camera module 36 captures images.

Furthermore, as described above, in an example embodiment, the orientation module 71 may determine the field of view (also referred to herein as angle of view) of the camera module 36. For example, given an initial image, a particular feature may be selected as the reference and thereafter, as the field of view is altered, the orientation module 71 may be configured to determine the orientation of the field of view of the camera module 36 based on the speed or amount of movement relative to the reference. This determination of the field of view may occur during exposure time intervals for images (e.g., successively captured images) being captured by the camera module 36. The field of view information may be provided by the orientation module 71 to the alignment module 78 which may determine the field of view (e.g., angle of view) between two consecutive images in horizontal and vertical directions.

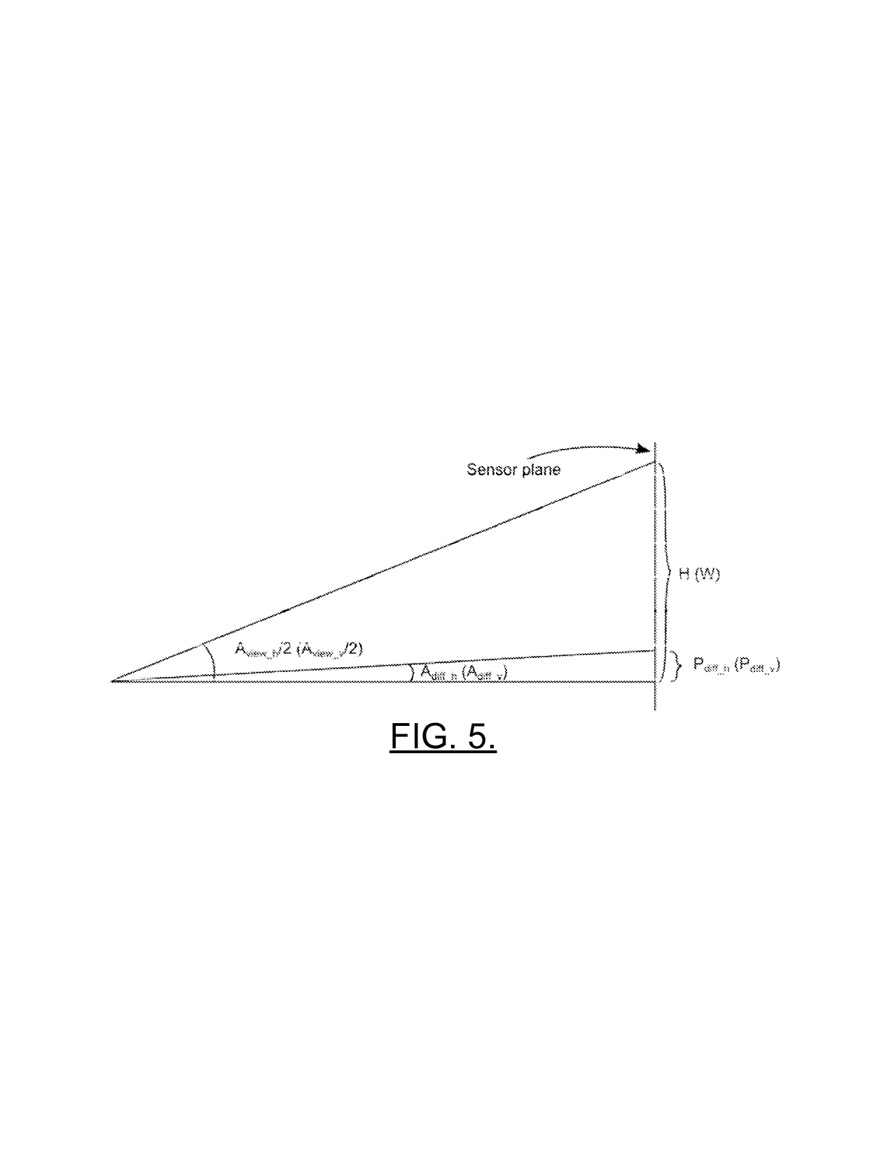

Referring now to FIG. 5, a diagram illustrating the manner in which rotation of camera module may affect pixel shift between two consecutively captured images of a sequence of captured images is provided according to an example embodiment. In this regard, FIG. 5 illustrates the pixel shift between two consecutive images in the horizontal dimension as well corresponding values in the vertical dimension.

In the example embodiment of FIG. 5, the alignment module 78 may utilize the determined angle of difference in horizontal directions (e.g., horizontal orientations) and vertical directions (e.g., vertical orientations), denoted A_{diff}_{_{—}}ₕ and A_{diff}_{_{—}}ᵥ, respectively and the determined angle of view of the camera module 36 (e.g., in both horizontal and vertical directions, denoted A_{view}_{_{—}}ₕ and A_{view}_{_{—}}ᵥ, respectively to determine differences in pixel shifts of images. In this example embodiment, the differences in terms of pixel shifts may be between each of two consecutively captured images of a same scene/location as determined by the alignment module 78 based in part on performing the calculations described below. The determined calculations are also depicted graphically in FIG. 5.

The alignment module 78 may determine the pixel differences between two consecutive images in the horizontal direction based in part on calculating P_{diff}_{_{—}}ₕ=W*tan(A_{diff}_{_{—}}ₕ)/tan(A_{view}_{_{—}}ₕ). Additionally, the alignment module 78 may determine the pixel differences between two consecutive images in the vertical direction based in part on calculating P_{diff}_{_{—}}ᵥ=H*tan(A_{diff}_{_{—}}ᵥ)/tan(A_{view}_{_{—}}ᵥ), where W denotes the width and H denotes the height (e.g., in number of pixels) of the captured images (e.g., two consecutively captured images).

In response to determining the pixel differences in the horizontal and vertical directions (e.g., P_{diff}_{_{—}}ₕ and P_{diff}_{_{—}}ᵥ), the alignment module 78 may utilize the computed values of P_{diff}_{_{—}}ₕ and P_{diff}_{_{—}}ᵥ for each pair of consecutively captured images to align the two consecutive images such that their orientations match or are substantially the same. In one example embodiment, the alignment module 78 may utilize the computed values of P_{diff}_{_{—}}ₕ and P_{diff}_{_{—}}ᵥ for each pair of consecutively captured images to align the two consecutive images by performing a translation in the image pixel domain. The translation of the target image may be performed, by the alignment module 78, in the opposite direction of the translation (e.g., in both vertical as well as horizontal directions), this may result in alignment of the target image with the reference image. This translation may result in a non-overlapping portion between the two images. In addition, this non-overlapping portion may be cropped or allowed to remain (e.g., depending on the application for the registration). In one example embodiment, the alignment module 78 may align two consecutively captured images by using the computed values of P_{diff}_{_{—}}ₕ and P_{diff}_{_{—}}ᵥ to shift the pixels of a target image (e.g., a subsequently captured image of the two consecutively captured images) to overlap or match the pixels of a reference image (e.g., a previously captured image of the two consecutive images). In another alternative example embodiment, the alignment module 78 may align two consecutively captured images by using the computed values of P_{diff}_{_{—}}ₕ and P_{diff}_{_{—}}ᵥ to shift the pixels of a reference image (e.g., a previously captured image of the two consecutive images) to overlap or match the pixels of a target image (e.g., a subsequently captured image of the two consecutively captured images).

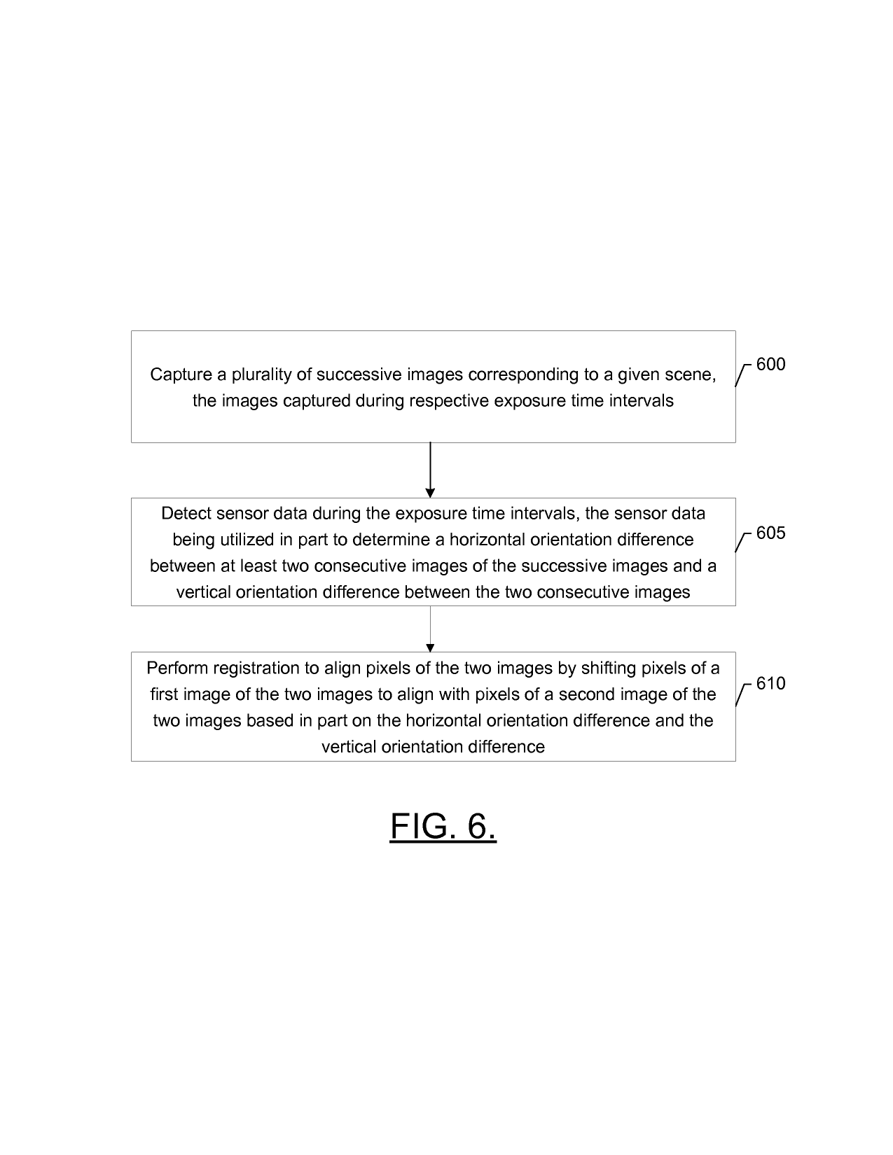

Referring now to FIG. 6, an example embodiment of a flowchart for performing image registration based in part on sensor data is provided. At operation 600, an apparatus (e.g., apparatus 50) may include means such as the camera module 36 and/or the like, for capturing a plurality of successive images corresponding to a given scene or location. The successive images may be captured during respective exposure time intervals. At operation 605, an apparatus (e.g., apparatus 50) may include means such as the processor 70, the orientation module 71, the alignment module 78 and/or the like, for detecting sensor data during the exposure time intervals. The sensor data may be utilized in part to determine a horizontal orientation difference between at least two consecutive images (e.g., an image one and image two, an image two and an image three, etc.) of the successive images (e.g., five consecutively captured images, etc.) and a vertical orientation difference between the two consecutive images. At operation 610, an apparatus (e.g., apparatus 50) may include means such as the processor 70, the alignment module 78 and/or the like, for performing registration to align pixels of the two consecutive images by shifting pixels of a first image of the two consecutive images to align with pixels of a second image of the two consecutive images based in part on the determined horizontal orientation difference and the determined vertical orientation difference.

It should be pointed out that FIG. 6 is a flowchart of a system, method and computer program product according to an example embodiment of the invention. It will be understood that each block of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 76, memory 96) and executed by a processor (e.g., processor 70, alignment module 78, a co-processor of camera module 36). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function(s) specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart blocks.

Accordingly, blocks of the flowchart support combinations of means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In an example embodiment, an apparatus for performing the method of FIG. 6 above may comprise a processor (e.g., the processor 70, the alignment module 78, the co-processor of camera module 36) configured to perform some or each of the operations (600-610) described above. The processor may, for example, be configured to perform the operations (600-610) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (600-610) may comprise, for example, the processor 70 (e.g., as means for performing any of the operations described above), the alignment module 78, the co-processor of the camera module 36 and/or a device or circuitry for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
capturing a plurality of successive images corresponding to a given scene, the images captured during respective exposure time intervals;
detecting sensor data during the exposure time intervals, the sensor data being utilized in part to determine a horizontal orientation difference between at least two consecutive images of the successive images and a vertical orientation difference between the two consecutive images; and
performing registration, via a processor, to align pixels of the two consecutive images by shifting pixels of a first image of the two consecutive images to align with pixels of a second image of the two consecutive images based in part on the determined horizontal orientation difference and the determined vertical orientation difference.

2. The method of claim 1, wherein the exposure time intervals comprise respective time periods in which light is exposed to enable capture of the successive images.

3. The method of claim 2, wherein one or more of the time periods of the exposure time intervals corresponds to different durations of time.

4. The method of claim 1, wherein prior to performing registration the method further comprises:
determining pixel differences in a horizontal direction between the two images based in part on a width corresponding to a number of pixels of each of the two images with respect to a determined angle of view of a media capturing device capturing the successive images.

5. The method of claim 4, wherein prior to performing registration the method further comprises:
determining pixel differences in a vertical direction between the two images based in part of a height corresponding to a number of pixels of each of the two images with respect to the determined angle of view of the media capturing device capturing the successive images.

6. The method of claim 5, further comprising utilizing the determined pixel differences in the horizontal direction and the determined pixel differences in the vertical direction in part to align the pixels.

7. The method of claim 1, wherein determine the horizontal orientation difference and the vertical orientation difference is based in part on obtained sensor measurements from a first sensor device indicating an orientation, in three dimensions, of a media capturing device capturing the successive images.

8. The method of claim 1, wherein:
determine the horizontal orientation difference is based in part on first sensor measurement data detected by a first sensor device during respective exposure time intervals in which the first and second images are captured; and
determine the vertical orientation difference is based in part on second sensor measurement data detected by a second sensor device during the respective exposure time intervals.

9. An apparatus comprising:
at least one processor; and
at least one memory including computer program code, the at least one memory and the computer program code configured to, with the at least one processor, cause the apparatus to perform at least the following:
capture a plurality of successive images corresponding to a given scene, the images captured during respective exposure time intervals;
detect sensor data during the exposure time intervals, the sensor data being utilized in part to determine a horizontal orientation difference between at least two consecutive images of the successive images and a vertical orientation difference between the two consecutive images; and
perform registration to align pixels of the two consecutive images by shifting pixels of a first image of the two consecutive images to align with pixels of a second image of the two consecutive images based in part on the determined horizontal orientation difference and the determined vertical orientation difference.

10. The apparatus of claim 9, wherein the exposure time intervals comprise respective time periods in which light is exposed to enable capture of the successive images.

11. The apparatus of claim 10, wherein one or more of the time periods of the exposure time intervals corresponds to different durations of time.

12. The apparatus of claim 9, wherein prior to perform registration the at least one memory and the computer program code are further configured to, with the processor, cause the apparatus to:
determine pixel differences in a horizontal direction between the two images based in part on a width corresponding to a number of pixels of each of the two images with respect to a determined angle of view of a media capturing device capturing the successive images.

13. The apparatus of claim 12, wherein prior to perform registration the at least one memory and the computer program code are further configured to, with the processor, cause the apparatus to:
determine pixel differences in a vertical direction between the two images based in part of a height corresponding to a number of pixels of each of the two images with respect to the determined angle of view of the media capturing device capturing the successive images.

14. The apparatus of claim 13, wherein the at least one memory and the computer program code are further configured to, with the processor, cause the apparatus to:
utilize the determined pixel differences in the horizontal direction and the determined pixel differences in the vertical direction in part to align the pixels.

15. The apparatus of claim 9, wherein the at least one memory and the computer program code are further configured to, with the processor, cause the apparatus to:
determine the horizontal orientation difference and the vertical orientation difference based in part on obtained sensor measurements from a first sensor device indicating an orientation, in three dimensions, of a media capturing device capturing the successive images.

16. The apparatus of claim 9, wherein the at least one memory and the computer program code are further configured to, with the processor, cause the apparatus to:
determine the horizontal orientation difference based in part on first sensor measurement data detected by a first sensor device during respective exposure time intervals in which the first and second images are captured; and
determine the vertical orientation difference based in part on second sensor measurement data detected by a second sensor device during the respective exposure time intervals.

17. A computer program product comprising at least one non-transitory computer-readable storage medium having computer-readable program code portions stored therein, the computer-readable program code portions comprising:
program code instructions configured to facilitate capture of a plurality of successive images corresponding to a given scene, the images captured during respective exposure time intervals;
program code instructions configured to detect sensor data during the exposure time intervals, the sensor data being utilized in part to determine a horizontal orientation difference between at least two consecutive images of the successive images and a vertical orientation difference between the two consecutive images; and
program code instructions configured to perform registration to align pixels of the two consecutive images by shifting pixels of a first image of the two consecutive images to align with pixels of a second image of the two consecutive images based in part on the determined horizontal orientation difference and the determined vertical orientation difference.

18. The computer program product of claim 17, wherein the exposure time intervals comprise respective time periods in which light is exposed to enable capture of the successive images.

19. The computer program product of claim 18, wherein one or more of the time periods of the exposure time intervals corresponds to different durations of time.

20. The computer program product of claim 17, wherein prior to perform registration, the computer program product further comprises:
program code instructions configured to determine pixel differences in a horizontal direction between the two images based in part on a width corresponding to a number of pixels of each of the two images with respect to a determined angle of view of a media capturing device capturing the successive images.
